(19) United States
(12) Patent Application Publication
(10) Pub. No.: US 2009/0182596 A1
(43) Pub. Date: Jul. 16, 2009

(54) METHOD AND SYSTEM OF ANALYZING CHOICES IN A VALUE NETWORK

(75) Inventors: Rama Kalyani Tirumala Akkiraju, Yorktown Heights, NY (US); Alain Ernest Biem, Mount Kisco, NY (US); Ryan Sougstad, Minneapolis, MN (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/014,543

(22) Filed: Jan. 15, 2008

(51) Int. Cl. G06F 17/00

(52) U.S. Cl. 705/7

(57) ABSTRACT

A method and system of analyzing choices in a value network, includes applying real options analysis to one or more choices. The real options include a present cost and a call value.

### BACKGROUND OF THE INVENTION

1. Field of the Invention

The present invention generally relates to a method and system of analyzing the costs, risks, and benefits of various choices in the context of a value network.

2. Description of the Related Art

Inter-organizational relationships are increasingly complex, with company's alternating roles as partners, competitors and complementors. A value network is a collection of firms or business units that coordinate actions around a common architecture to deliver interdependent elements of an overall value proposition. Value network analysis has emerged as a theoretical and strategic method to analyze these complex relationships. Within the value network, a firm faces many decisions such as: which value networks to enter, how to hedge risks associated with tying up too closely with one value network, and how to stage decisions when participating in a value network that has inherent uncertainties in the value propositions offered by partners. Present value network analysis techniques are insufficient in their ability to help answer questions such as the ones raised above.

Whereas traditional value chain analysis usually considers only the horizontal elements across the supply chain, value networks consider vertical elements such as complementors, competitors, influencers and strategic alliance partners. A value network analysis involves a firm's understanding of how its offering is positioned in terms of the final customer value, and how other nodes effect that final value proposition.

In today's environment of increased outsourcing, blurred lines of industry demarcation and cooperation, companies are continually finding themselves in networked situations that involve multiple business partners. Hence, as mentioned above, questions such as which value networks to enter, how to hedge risks associated with tying up too closely with one value network and how to stage decisions when participating in a value network that has inherent uncertainties in the value propositions offered by partners are increasingly drawing management attention. Some work has already been done to study value networks from a theoretical point of view and to provide a descriptive approach to making decisions around value networks. (Hakanson and Johanson, 1992, Norman and Ramirez, 1993, Gulati, 1998) and to provide a descriptive approach (Allee 2002, Parolini 1999, Bovet and Martha, 2000) to making decisions around value networks.

However, methods to systematically analyze the value of participating in a network while considering the strategic flexibility managers may have in dealing with uncertainties in a value network are lacking in the prior art.

Companies traditionally approach investment decisions based on accounting analysis with methods such as net present value (NPV) based on discounted cash flows (DCF) or internal rate of return (IRR). While these methods do account for risk within the discount rate, they do not consider the managerial flexibility inherent in some decisions. For example, rather than commit to acquisition immediately, a firm may choose to invest in further capabilities, and then decide at a future time if it is worth acquiring a company or not. A conventional NPV analysis of the decision to invest in capability development does not capture the flexibility associated with the manager's ability to delay or abandon this capability investment if competitive conditions play out unfavorably.

Such conventional approaches cannot value the contingent nature of the exploitation decisions such as, “If things go well, then we'll invest in additional resources to participate in that value network.” They do not consider uncertainty well. Further, the conventional methods do not account for staged investment options over time. Thus, a need exists for a method and tool to analyze choices in a value network.

### SUMMARY OF THE INVENTION

The present inventors have developed an options-based approach for analyzing value network choices. Further, the inventive method measures the value of managerial flexibility. The method enables managers to stage value network decisions over time in the face of uncertainty. This approach informs managerial decision making by identifying the strategic paths available to networked companies and evaluating the potential benefits of options to defer decisions around partnerships. The method measures the extra value that a company could potentially obtain by staging decisions of value network entry in cases where uncertainties abound. The claimed method represents the application of a quantitative real options approach to value network analysis and offers valuable, actionable, managerial guidance.

In a first exemplary aspect of the present invention, described herein is a method of analyzing choices in a value network, including applying real options analysis.

Preferably, the choices include choosing partnerships.

Preferably, the choices include choosing partner value networks.

Preferably, the method includes obtaining a set of value network options, and encoding a set of value networks as a value network model.

Preferably, the method includes preparing a value network model of participation in a current value network, conducting options analysis on the set of value network options, and refining the value network model.

Preferably, the value network options comprise staged network participation.

Preferably, the real options analysis assesses a value of managerial flexibility.

Preferably, the real options analysis assesses an opportunity cost of participation in a value network.

Preferably, the real options analysis provides an ability to mitigate an opportunity cost of foregoing participation in alternative value networks.

Preferably, the ability to mitigate an opportunity cost comprises an investment in an option, the option providing a right but not an obligation to participate in the alternative value networks.

Preferably, the option constrains the opportunity costs to be within impacts, on a market demand, of delaying decisions by a given time period.

Preferably, the real options analysis is modeled as a stock option.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 shows an example of a hypothetical choice in a value network 100;

FIG. 2 exemplarily shows option model variables 200 used in the method of the present invention;

FIG. 3 shows an example 300 of Net Present Value calculations as done in the traditional way without the application of real-options analysis;

FIG. 4 shows an example 400 of the value of an option in an example;

FIG. 5 shows an example 500 of Black-Sholes pricing computation to derive the extra value of staging a value network decision;

FIG. 6 shows a flow chart 600 of an embodiment of the method of the present invention;

FIG. 7 illustrates an exemplary hardware/information handling system 700 for incorporating the present invention therein; and

FIG. 8 illustrates a signal bearing medium 800 (e.g., storage medium) for storing steps of a program of a method according to the present invention.

### DETAILED DESCRIPTION OF EXEMPLARY EMBODIMENTS OF THE INVENTION

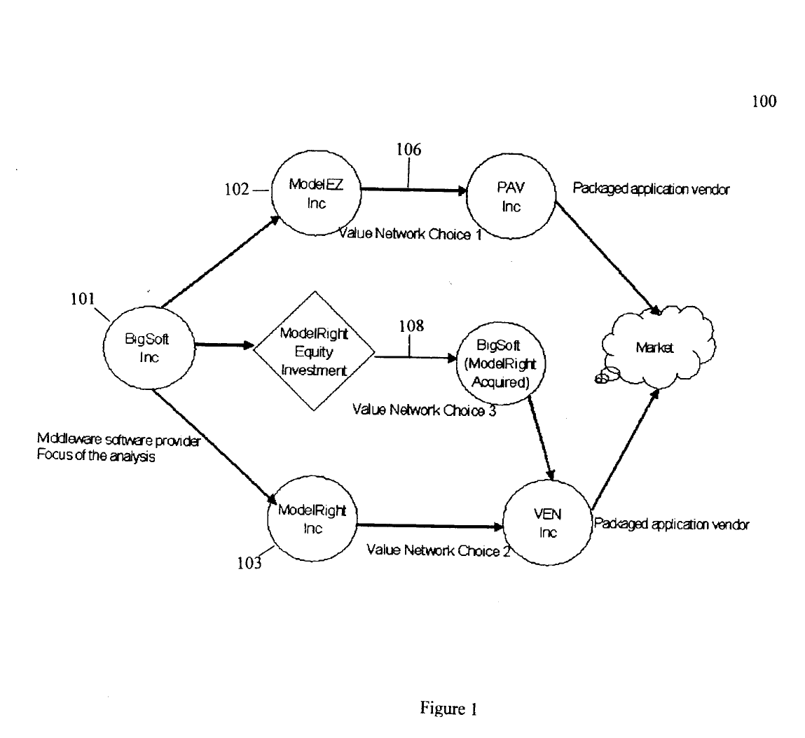

Referring now to the drawings, and more particularly to FIG. 1, there is shown an illustrative example of an embodiment of the method according to the present invention.

### Hypothetical Case: BigSoft

As an illustration of the method, consider the following example 100 shown in FIG. 1.

A focal point of an exemplary analysis is BigSoft 101, a hypothetical firm that specializes in developing and selling highly scalable and highly available middleware software. BigSoft is a market leader in developing infrastructure middleware, and application development studios, but lacks capabilities in application modeling space. BigSoft's target market segment is all enterprise-scale companies in most industry segments (Retail, Financial Services, Consumer Packaged Goods, Communications, Government etc).

In order to deliver software solutions to clients in these market segments, BigSoft must work with partners that can (a) complement its offerings by providing modeling capabilities, and (b) provide industry specific solutions. Therefore, in this exemplary setting, a value network decision that BigSoft 101 faces is: which of two potential modeling candidates to form a partnership with?

The two hypothetical candidate modeling companies are: (1) ModelEZ 102, that holds a dominant position in market share in the modeling space; and (2) ModelRight 103, that holds the second position in market share in the modeling space.

ModelEZ's 102 products are based on proprietary platform and proprietary modeling language, whereas ModelRight's 103 products are based on an open platform. ModelRight 103 is pushing to standardize the modeling language that it uses, via a respected standards organization. Competing proposals are on the table with the standards organization for modeling languages, and no standard has yet been established, but ModelRight's 103 proposal seems to be one of the leading contenders.

Consider the case where BigSoft 101 already has an established relationship with a packaged application vendor PAV, Inc., that provides industry solutions for many industries, but BigSoft 101 can also work with other competing vendors such as VEN, Inc. The two alternative value network choices for BigSoft 101, which is the focal point of the present analysis, are illustrated in FIG. 1.

By choosing value network 1 (106), BigSoft 101 can form a partnership with ModelEZ 102, the current market leader in modeling space, and together with PAV, Inc. 104, can deliver a solid value proposition to the client. This is represented as value network choice 1 in FIG. 1.

Alternatively, by choosing value network 2 (107), BigSoft 101 can form a partnership with ModelRight 103, which currently lags behind ModelEZ 102 in market share, and together with a different packaged vendor provider VEN, Inc. 105, can deliver an almost comparable value proposition as with value network 1. This is represented as value network choice 2 (107) in FIG. 1.

Now consider a situation in which a third alternative 108 is also available. If the standards organization adopts ModelRight's proposal, then ModelRight could eventually become a market leader in the modeling space field. In order to help facilitate this standards adoption, BigSoft 101 has the option to make an equity-based investment 109 (with a right of first refusal clause) in ModelRight's capability, in exchange for the right (but not an obligation) to acquire ModelRight 110 at a future time. In this scenario, BigSoft will have a more central role in the value proposition of the network, and has the potential to a greater cash flow than the other two scenarios if the standards adoption turns favorable. This is modeled as value network choice 3 in FIG. 1. However, there is also a chance that ModelRight's 103 proposal might not be adopted by the standards organization. So, there is uncertainty associated with the expected cash flows from this value network choice 3.

Using a conventional valuation approach, one could conclude that choosing value network 1 is the optimal decision. Conventional analysis might conclude that participating in value network 1 offers a superior value proposition to the client (which translates into higher price, yielding higher margins for all participants in the network) with stable technology platforms. The conventional approach, however, does not consider the value of the equity investment 109 and option to buy ModelRight 110.

However, the investments made in partnering with ModelRight 103 (for integrating products and preparing sales materials and training technical sales teams, etc.) in value network 2 may offer extra value, because value network 2 enables BigSoft 101 to buy an option (but not the obligation) to create a joint venture with ModelRight 103 at a later time. Assume that this venture would create a higher overall value proposition for BigSoft 101 than one in which BigSoft 101 and ModelRight 103 are able to deliver via an arms-length relationship today. This assumption is reasonable because this is the logic that often drives companies to make acquisitions, rather than sticking with alliances. This flexibility that is inherent in value network 2 is not captured by conventional valuation approaches.

However, the value of this flexibility is analyzed and estimated in the present method by applying real-options analysis. In the real world, companies often find themselves in the kind of multi-party plays outlined in this example. Understanding the inter-dependencies among the networked organizations, and making decisions on choosing, nurturing and managing the relationships with partners effectively is increasingly drawing management attention. In this setting, strategists often must make critical business decisions without support from analytical methods and tools. The present invention utilizes a real options-based approach to analyzing alternatives in value network participation.

### Real Option Analysis and Value Networks

Companies traditionally approach investment decisions based on accounting analysis with methods such as net present value (NPV) based on discounted cash flows or internal rate of return (IRR). While these methods account for risk within the discount rate, they do not consider the managerial flexibility inherent in some decisions.

For example, rather than commit to an acquisition immediately, a firm may chose to invest in further capabilities, and then decide at a future time whether or not it is worth acquiring a company, as indicated in our example scenario. A conventional NPV analysis of the decision to invest in capability development does not capture the flexibility associated with the manager's ability to delay or abandon this capability investment if competitive conditions play out unfavorably. To measure this flexibility, the present invention uses a real-options approach.

Real-options approach is derived from the concept of financial options. In financial options, an option provides the bearer the right to buy (call) or sell (put) an asset, at a pre-specified price, at a specific future date. Consider the following simple example to illustrate the setup of a financial option. The buyer of a European call option might pay $10 to purchase the right, but not the obligation, to purchase one stock of FictionalSoftware, Inc., at an exercise price of $100 one year from now. The current price of one stock of FictionalSoftware is $85. If one year from now the stock price of FictionalSoftware Inc rises to $130, then the buyer makes a profit of $20. This is because she has purchased the stock at $100 and could sell in the market for $130 (i.e., for a $30 gain), but the buyer must subtract the $10 option price, that she had to pay to purchase the option, from this $30 profit,

On the other hand, if a year from now the stock price of FictionalSoftware did not go up as the buyer had anticipated, then she is not obligated to purchase the stock at $100. Thus, the maximum she could lose is the $10 (i.e., the price of the option) she paid a year ago. Therefore, a financial option limits buyers' losses to the cost of the option, while allowing unlimited profits.

Black and Scholes (1972) were among the first to build option pricing models based on replicating portfolios of the option asset and a risk-free asset. A real options analysis, as used in the present invention, applies such option thinking to real assets. The value of managerial flexibility is equated to the value of an option, because flexibility enables managers to expand, or abandon an investment, depending on market conditions, with a right but not the obligation to do so. Real options are thus used to strategically identify staging points by which firms can expand, abandon or defer investments. In addition, real options are used to compare investment alternatives where there is 1) uncertainty in the value, and 2) the potential for managerial flexibility to address the uncertainty.

The present invention considers an option associated with joining a value network through a potential partner, or building capabilities to enter the value network at a position that is more advantageous, for example through a different set of partners or consumer markets.

In this example, the Black-Scholes method for valuing European call options is used for simplicity. In a European call option, the option can only be exercised at the end of the set time period. Black-Scholes formula is given in equation (1) below.

C(S,T)=SN(d1)−Xe−rTN(d2) (1)

where d1=[ln(S/X)+(r+a2/2)T]/(σ√T) (2)

and d2=d1−σ√T (3)

where N represents the standard normal cumulative distribution, and in represents the natural logarithm.

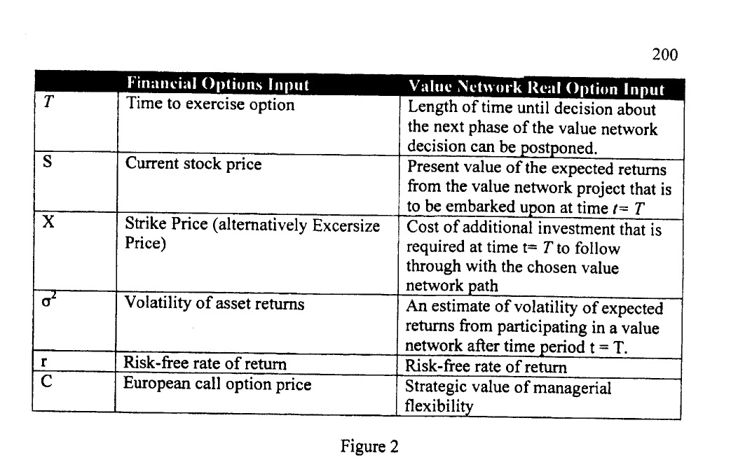

The meaning of the remaining terms used in the Black-Scholes formula, along with their interpretation in a generic value network setting, are as given in table 1 FIG. 2.

Now return to the example, to examine the interpretation of the Black-Scholes method for estimating the value of the BigSoft 101's flexibility in making an equity investment in ModelRight 103, with an optional right but not the obligation to buy ModelRight 103 at a later time.

First, time ‘t’ in the case of the exemplary scenario is the length of time until BigSoft 101 can postpone the decision of whether or not to acquire ModelRight 103. This is determined by the timing of when the modeling language standard is announced by the standards organization. The current stock price represents the expected value of returns associated with the value-network entry decision. In this example, this implies the present value of potential benefits to be incurred by BigSoft 101 by acquiring ModelRight 103 after the announcement of the modeling standard by the standards organization. The strike price, or exercise price, represents the cost or additional price that BigSoft 101 must pay ModelRight 103 to acquire the remaining part of the company.

Suppose that initially BigSoft 101 pays to acquire 33% of ModelRight 103 in equity. The strike price would be the money that BigSoft 101 would have to pay ModelRight 103 to acquire the remaining 67%. The standard deviation of asset returns corresponds to the uncertainty associated with the expected returns from acquiring ModelRight 103 fully, at an initial time of t=0. Option price represents the price the purchaser of the option must pay to acquire the right but not the obligation to exercise the option. A purchaser will pay the option price only if the option is worth it to her. Therefore, the option price is analogous to the value of managerial flexibility in delaying the decision making in the case of value network analysis. In the case of our example, this would be the price BigSoft 101 pays to acquire a partial equity (say 33%) in ModelRight 103 to buy the first right of refusal to acquire ModelRight 103 soon after the standards decision is announced by the standards organization.

Now examine the expected returns for BigSoft 101 for each of the value network choices presented in FIG. 1. Assume that BigSoft 101, the focal firm, chooses the profit-maximizing decision.

First, compare the net present value (NPV) or discounted cash flows for three distinct decision paths without options. The method considers partnering with Model EZ (value network choice 1, FIG. 1). The method then looks at the NPV of joining a traditional partnership with ModelRight 103 (value network choice 2, FIG. 1). The method also considers the NPV if the firm were to immediately acquire ModelRight 103, independent of any option. Finally, the method computes the value of value network choice 3, where BigSoft 101 can postpone a decision regarding acquiring ModelRight 103 until after the announcement by the standards organization.

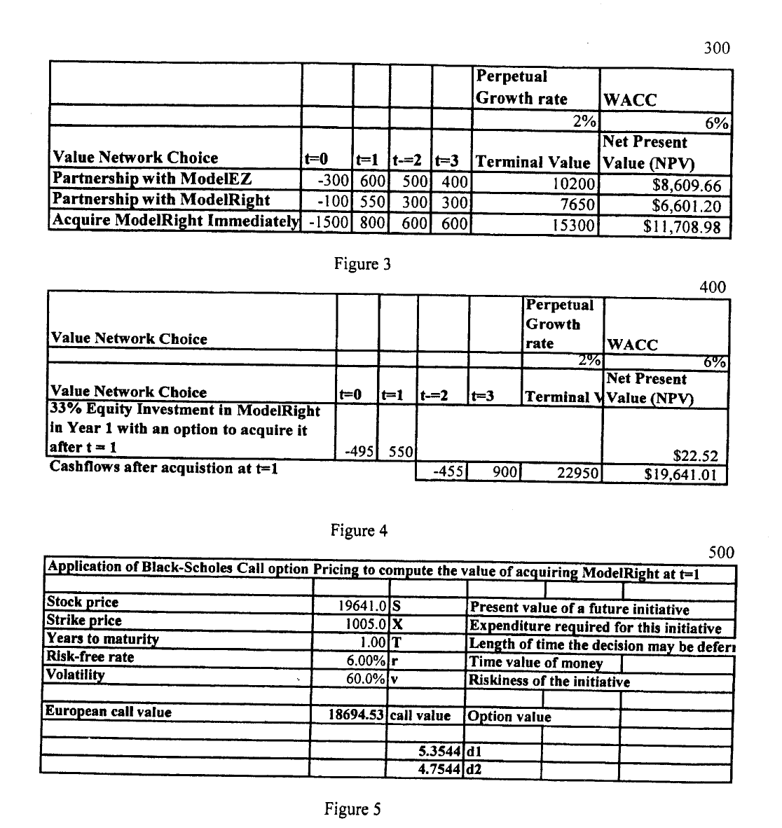

FIG. 3 shows the expected profits in present day's terms for each of the value network choices computing using conventional net present value approach. From FIG. 3, a partnership with the market leader, ModelEZ 102 is better than partnering with ModelRight 103. Acquiring ModelRight 103 is an attractive option according to the conventional NPV calculation. However, the conventional analysis cannot consider the uncertainty associated with the standards decision around acquiring ModelRight 103 immediately. If ModelRight's 103 modeling language standard is not eventually adopted, then these conventional NPV calculations are unreliable.

### Option Value of Deferring the Value Network Decision

Now examine BigSoft 101's value of postponing the ModelRight 103 acquisition decision until the standards announcement is made. The method analyzes the value of this option to defer, and later make, a decision about acquiring ModelRight 103. The example is illustrated in FIG. 4.

First, compute the cashflows associated with one year i.e., the duration during which decision to acquire ModelRight 103 can be postponed. For example, NPV of this stage is: $22.52 (in thousands). At time t=1, if BigSoft 101 were to acquire ModelRight 103, then the expected NPV is: $19,641 (in thousands). This expected NPV feeds in the computation of option value shown in FIG. 5. Strike price of $1005 is the cost of purchasing the remaining 67% of equity in ModelRight 103 (33% of $1500 i.e., $495 that it costs to purchase 33% of equity stake in ModelRight 103 is already invested at t=0 in Table 3).

To assess the value of the real option on the ModelRight 103 acquisition, the method draws upon inputs of the Black-Scholes option pricing model explained in Table 1. Table 4 summarizes the Black-Scholes computation. The value of the option is $18,694. This is the value of managerial flexibility. This value is in addition to the $22.52 obtained in time period t=1. Therefore, the total NPV of acquiring ModelRight 103 is $18,717. This value is much higher than any of the three choices available for BigSoft 101 in the example, including acquiring ModelRight 103 immediately.

Thus, real options analysis captures the value of this flexibility. The conventional methods are incapable of such analysis and capturing such value.

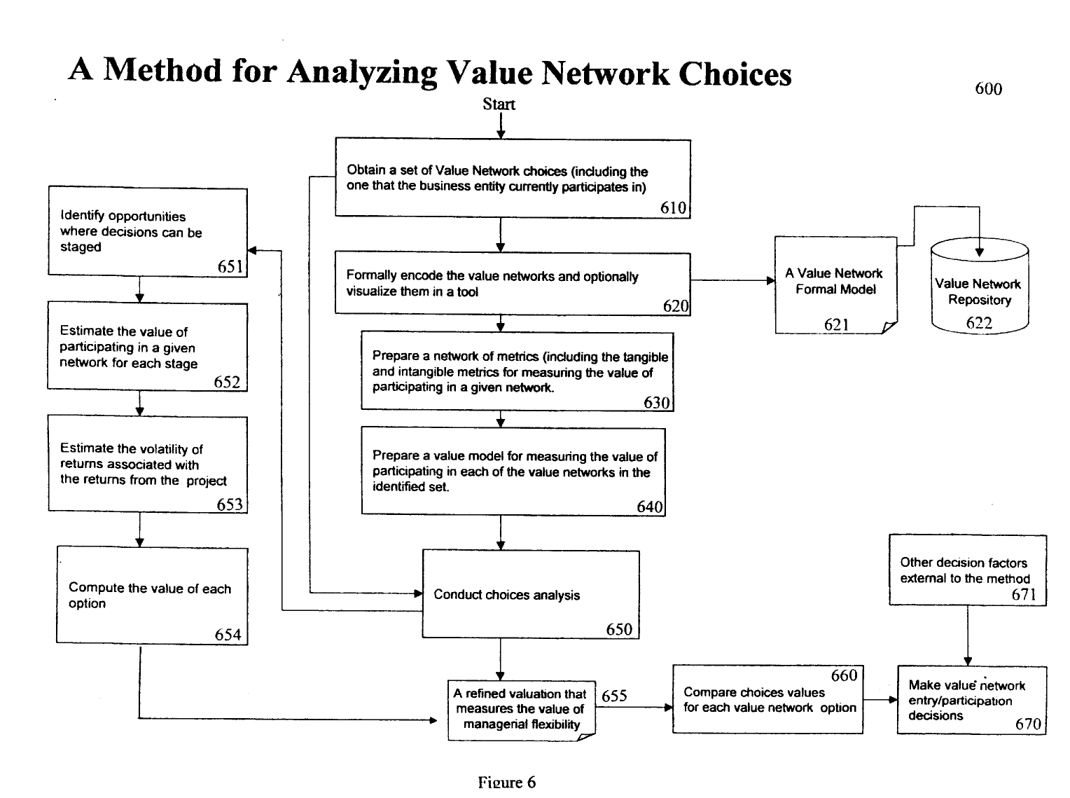

The claimed method 600 is summarized in FIG. 6 as a flowchart. The following exemplary method is presented for analyzing value network choices in the invention:

Step 1: First step 610 is to obtain a set of value network choices that are to be investigated. This includes the current value network that the company for whom the analysis is being done is involved in (if any).

Step 2: Then, optionally, each of the value network choices can be formally encoded and visualized 620 using visual tools. The Value Network Formal Models 621 may be stored in a Value Network Repository 622. This optional step could provide valuable insights about each of the choice via visual clues.

Step 3: To help assess the value of participating in each of the network, next is proposed the development 630 of a consistent set of metrics for valuing the value network choices. These metrics could include the tangible metrics such as ‘the amount of revenue obtained from doing business with partner A’ which can be measured in currency and/or intangible metrics such as the loyalty of partner A which are hard to measure but proxies such as ‘the average amount of repeated revenue obtained from doing business with partner A in the past 4 years’ can be used.

Step 4: Once a list of tangible and intangible metrics are obtained a value model for assessing the value of network participation has to be developed 640. Here, as described in the BigSoft exemplar, one can use traditional valuation techniques such as the discounted cash flow (DCF).

Step 5: Choices are analyzed 650. Valuations for each of the value network choices from Step 4 serve as inputs to step 5. Step 5 captures the main idea of the invention. The details of step 5 are shown in detail in the flow diagram of steps 651-654 of the left portion of flowchart 600.

Step 5a. For each of the value network choices, identify opportunities where decisions can be staged 651 where some amount of uncertainty is involved in staging the value network participation. If no uncertainty is involved then the additional value to be computed from this approach would be equal to the traditional discounted cash flow approach.

Step 5b. Then estimate 652 the value of participating in each of the networks identified in step 1 for each stage, taking into consideration the timing of when each project starts and ends.

Step 5c. Estimate 653 the volatility of staging each of the value network choices next. To estimate the volatility, one can consider volatility associated with similar ventures embarked up on similar companies in the past.

Step 5d. Then compute 654 the value of staging decisions by taking the volatility estimate, valuations for value network participation, and time period of analysis into account. One approach to compute the value of an option is to use the approach suggested by Black-Sholes.

Step 5e: The results of steps 5a through 5d give a refined valuation 655 that measures the value of managerial flexibility in postponing/staging some of the value network decisions.

Step 6: The results of the value of options for each value network choice are added 660 to the traditional valuation assessed in step 4.

Step 7: Decisions are enabled 670 by taking the results of this analysis in conjunction with other decision factors 671 external to the method.

### Understanding When to Stage Value Network Decisions

One of the major issues with options analysis is its sensitivity to initial inputs, especially the estimates of volatility of future cash flows. Estimating the volatility of expected returns is a difficult problem in itself and is outside the scope of the present invention. However, understanding the impact of the variance of volatility is of paramount importance when evaluating value network options. Since it is difficult to assess the exact standard deviation of expected returns, it is imperative to run sensitivity analysis to understand the impact of these variations on expected returns.

The key insight to be obtained from sensitivity analysis is to understand that the value of the option increases as the volatility increases. If the expected returns from the project that is being investigated at time t=T are highly uncertain, then staging a decision can buy some time, which can help resolve some aspects of uncertainty. Since a real option limits the losses while posing no limits on the obtainable profits, higher uncertainty can only help the case for higher expected returns.

By the same token, if the uncertainty of the expected returns from future projects is low, then, the value of the option will also be low. In fact, if there is no uncertainty in the expected returns at all, then the value of the option is zero. This means that the value of the project is then equal to the value computed via the conventional discounted cash flow approach. Therefore, BigSoft 101 making an equity investment in ModelRight 103 and waiting for the standards announcement is an appropriate choice because there is a fair degree of uncertainty associated with the standards decision. If a favorable standards decision will not change the market perception of ModelRight 103 (i.e., low uncertainty about the expected returns from acquiring ModelRight 103), then making an equity investment in ModelRight 103 may not be worthwhile for BigSoft 101.

Thus, the present invention provides a real options based approach to analyzing the value of managerial flexibility in value network decisions. Specifically, the method presents an approach to analyze (a) which value networks to enter, (b) how to hedge risks associated with tying up too closely with one value network, and (c) how to stage decisions when participating in a value network that has inherent uncertainties in the value propositions offered by partners.

### Exemplary Hardware Implementation

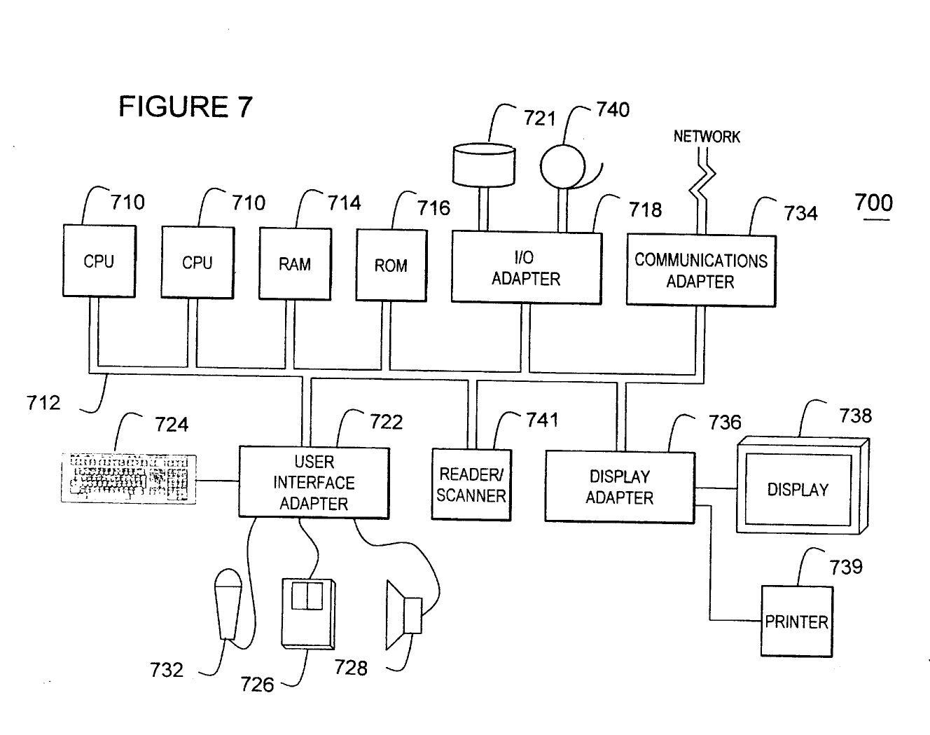

FIG. 7 illustrates a typical hardware configuration of an information handling/computer system in accordance with the invention and which preferably has at least one processor or central processing unit (CPU) 711.

The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, an Intranet, a personal area network (PAN), etc., and a display adapter 736 for connecting the bus 712 to a display device 738 and/or printer 739 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 711 and hardware above, to perform the method of the invention.

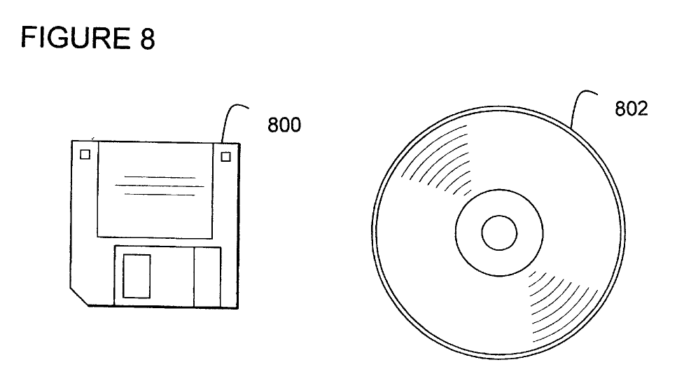

This signal-bearing media may include, for example, a RAM contained within the CPU 711, as represented by the fast-access storage for example. Alternatively, the instructions may be contained in another signal-bearing media, such as a magnetic data storage diskette 800 (FIG. 8), directly or indirectly accessible by the CPU 711.

Whether contained in the diskette 800, the computer/CPU 711, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

Having thus described our invention, what we claim as new and desire to secure by Letters Patent is as follows:

1. A method of analyzing choices in a value network, comprising applying real options analysis to one or more of said choices, said real options comprising a present cost and a call value.

2. The method of claim 1, wherein said choices comprise choosing partnerships from a selection of alternatives.

3. The method of claim 1, wherein said choices comprise choosing partner value networks from a selection of alternatives.

4. The method of claim 1, wherein said choices comprise staging points at which a business expands, abandons, or defers investments.

5. The method of claim 1, wherein said real options are used to compare investment alternatives having uncertain value.

6. The method of claim 1, further comprising:
obtaining a set of value network options; and
encoding a set of value networks as a value network model.

7. The method of claim 6, further comprising:
preparing a value network model of participation in a current value network;
conducting options analysis on said set of value network options; and
refining said value network model.

8. The method of claim 7, wherein said value network options comprise staged network participation.

9. The method of claim 1, wherein said real options analysis assesses a value of managerial flexibility.

10. The method of claim 9, wherein said real options analysis assesses an opportunity cost of participation in a value network.

11. The method of claim 9, wherein said real options analysis mitigates an opportunity cost of foregoing participation in alternative value networks.

12. The method of claim 11, wherein said mitigating an opportunity cost comprises investing in an option, said option providing a right but not an obligation to participate in said alternative value networks.

13. The method of claim 11, wherein said option constrains said opportunity costs to be within impacts, on a market demand, of delaying decisions by a given time period.

14. The method of claim 1, wherein said real options analysis is modeled as a stock option.

15. A computer-readable medium on which are encoded machine-readable instructions which, when executed, cause a computer to perform analysis of choices in a value network,
said analysis comprising applying real options analysis to one or more of said choices,
said real options comprising a present cost and a call value.

16. A digital computer comprising the computer-readable medium of claim 15.

17. The method claim 1, further comprising selecting one of said analyzed choices, where said analysis indicates said selected choice comprises a greatest value.

18. The method claim 1, further comprising selecting one of said analyzed choices, where said analysis indicates said selected choice comprises a minimum value.

19. A system for analyzing choices in a value network, comprising:
a real options analysis portion which applies real options analysis to one or more of said choices; and
a selection portion which selects one of said analyzed choices comprising a greatest value,
said real options comprising a present cost and a call value.
